(19) United States
(12) Patent Application Publication
(10) Pub. No.: US 2011/0114567 A1
(43) Pub. Date: May 19, 2011

(54) PRECIPITATION DEVICE, METHOD AND ASSOCIATED SYSTEM

(76) Inventors: Zijun Xia, Shanghai (CN); Rihua Xiong, Shanghai (CN); Jiyang Xia, Shanghai (CN); Chengqian Zhang, Shanghai (CN); James Manio Silva, Clifton Park, NY (US); Weiming Zhang, Shanghai (CN); Wei Cai, Shanghai (CN)

(21) Appl. No.: 13/015,466

(22) Filed: Jan. 27, 2011

Related U.S. Application Data
(63) Continuation-in-part of application No. 12/512,324, filed on Jul. 30, 2009.

(30) Foreign Application Priority Data
Jan. 29, 2010 (CN) 2010101105019.4

(51) Int. Cl. C02F 1/52; B01D 21/28; B01D 21/02

(52) U.S. Cl. 210/714; 210/256; 210/195.3; 204/627; 204/660; 210/702; 210/738

(57) ABSTRACT

A precipitation device comprises a precipitation element disposed within a vessel and configured to define a precipitation zone and a solid-liquid separation zone between the precipitation element and the vessel, the precipitation zone configured to receive a first stream of saline liquid and to precipitate solids from the saline liquid, the solid-liquid separation zone configured to settle the solids by gravity, and an exit port located in an upper portion of the vessel and configured for exit of a second stream of liquid of lower salinity than the first stream, wherein a ratio of a diameter of the vessel to a diameter of the precipitation element ranges from about 1.5 to about 2.8. Associated system and method are also provided.

### CROSS REFERENCE TO RELATED APPLICATION

This application is a continuation-in-part of U.S. patent application Ser. No. 12/512,324 filed on Jul. 30, 2009 and titled as DESALINATION SYSTEM AND METHOD.

### BACKGROUND

The invention relates generally to liquid treatment devices, methods, and associated systems. More particularly, this invention relates to precipitation devices, methods and associated systems for decreasing the salinity of saline liquids.

Saline liquids such as concentrate water from wastewater/brackish water desalination devices, e.g., supercapacitor desalination devices or electrodialysis reversal devices, generally need to be processed before recycle to decrease their salinity by removing or reducing salts which include, but are not limited to, sodium chloride, magnesium and calcium sulfates, and bicarbonates.

Precipitation is an approach to decrease the salinity of saline liquid. However, currently available precipitation devices are often designed primarily for obtaining crystals with desired qualities and either are complex in their construction or operate at high temperatures or low pressures, which leads to high capital and/or operating costs.

Therefore, there is a need to develop a precipitation device, method, and associated system to decrease the salinity of the liquid at lower cost.

### BRIEF DESCRIPTION

In one aspect, a precipitation device is provided. The precipitation device comprises: a precipitation element disposed within a vessel and configured to define a precipitation zone and a solid-liquid separation zone between the precipitation element and the vessel, the precipitation zone configured to receive a first stream of saline liquid and to precipitate solids from the saline liquid, the solid-liquid separation zone configured to settle the solids by gravity, and an exit port located in an upper portion of the vessel and configured for exit of a second stream of liquid of lower salinity than the first stream, wherein a ratio of a diameter of the vessel to a diameter of the precipitation element ranges from about 1.5 to about 2.8.

In another aspect, a system is provided. The system comprises the precipitation device, and a desalination device providing the first stream to the precipitation device and receiving the second stream from the precipitation device.

In yet another aspect, a method is provided. The method comprises: providing a precipitation device comprising: a precipitation element disposed within a vessel and configured to define a precipitation zone and a solid-liquid separation zone between the precipitation element and the vessel, and an exit port located in an upper portion of the vessel, wherein a ratio of a diameter of the vessel to a diameter of the precipitation element ranges from about 1.5 to about 2.8, providing a first stream of saline liquid into the precipitation zone to precipitate solids from the saline liquid, settling the solids by gravity in the solid-liquid separation zone, and releasing a second stream of liquid of lower salinity than the first stream through the exit port.

These and other advantages and features will be better understood from the following detailed description of preferred embodiments of the invention that is provided in connection with the accompanying drawings.

### BRIEF DESCRIPTION OF THE DRAWINGS

FIG. 1 is a schematic diagram of a precipitation device in accordance with one embodiment of the present invention;

FIG. 2 is a schematic diagram of a desalination system comprising the precipitation device of FIG. 1 and a supercapacitor desalination (SCD) device;

FIG. 3 is a schematic diagram of the precipitation device of FIG. 1 connected with an electrodialysis reversal (EDR) device;

FIG. 4 is a schematic diagram of the precipitation device of FIG. 1, connected with a desalination device, an evaporator and a crystallizer;

FIG. 5 is a schematic diagram of a precipitation device in accordance with another embodiment of the invention;

FIG. 6 is a schematic diagram of a precipitation device in accordance with a third embodiment of the invention;

FIG. 7 is a schematic diagram of a precipitation device in accordance with a fourth embodiment of the invention;

FIG. 8 is a schematic diagram of a precipitation device in accordance with a fifth embodiment of the invention;

FIG. 9 is a schematic diagram of a precipitation device in accordance with a sixth embodiment of the invention;

FIG. 10 is a schematic diagram of a precipitation device in accordance with a seventh embodiment of the invention;

FIG. 11 is a schematic diagram of a precipitation device in accordance with an eighth embodiment of the invention;

FIG. 12 shows a cross-sectional view of a precipitation device used in the example; and

FIG. 13 shows a schematic operation view of the precipitation device of FIG. 12.

### DETAILED DESCRIPTION

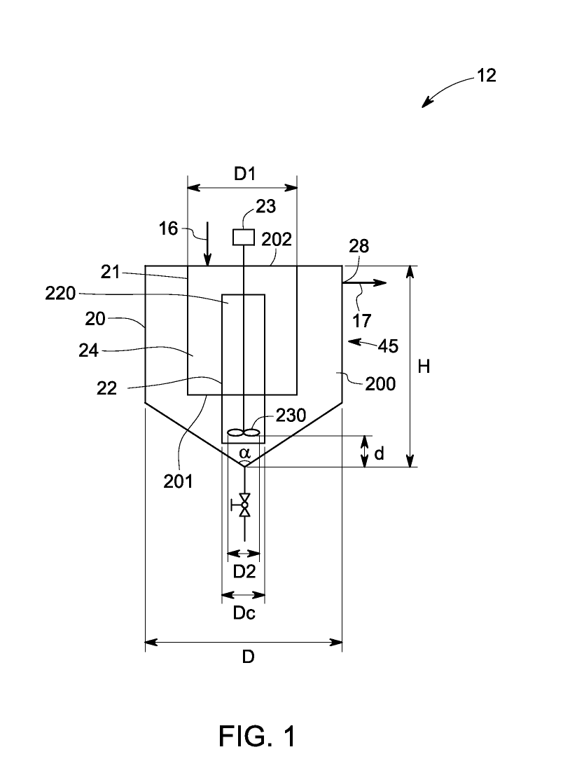

Preferred embodiments of the present disclosure will be described hereinbelow with reference to the accompanying drawings. The same numerals in FIGS. 1-4 may indicate the similar elements. In the following description, well-known functions or constructions are not described in detail to avoid obscuring the disclosure in unnecessary detail.

Approximating language, as used herein throughout the specification and claims, may be applied to modify any quantitative representation that could permissibly vary without resulting in a change in the basic function to which it is related. Accordingly, a value modified by a term or terms, such as “about” or “substantially”, is not to be limited to the precise value specified. In some instances, the approximating language may correspond to the precision of an instrument for measuring the value. Moreover, the suffix “(s)” as used herein is usually intended to include both the singular and the plural of the term that it modifies, thereby including one or more of that term.

FIG. 1 is a schematic diagram of a precipitation device 12 in accordance with one embodiment of the present invention. The precipitation device 12 comprises: a precipitation element 21 disposed within a vessel 20 and configured to define a precipitation zone 24 and a solid-liquid separation zone 200 between the precipitation element 21 and the vessel 20. The precipitation zone 24 is configured to receive a first stream of saline liquid 16 and precipitate solids (not shown) from the saline liquid. The solid-liquid separation zone 200 is configured to settle the solids by gravity. An exit port 28 is located in an upper portion 45 of the vessel 20 and is configured for exit from the solid-liquid separation zone 200 of a second stream 17 of liquid of lower salinity than the first stream.

The salinity of the second stream 17 of liquid is affected by many factors, e.g., construction of the precipitation device 12. The precipitation element 21 and the upper portion 45 of the vessel 20 have hollow cylindrical shapes. The precipitation element 21 comprises a lower opening 201 in communication with the vessel 20. Additionally, an upper opening 202 in communication with the lower opening 201 of the precipitation element 21 may or may not be provided to communicate with the vessel 20. In some embodiments, a flow rate per unit cross-sectional area in the solid-liquid separation zone is about 0.12 to about 0.48 gallons per minute per square foot cross-sectional area (gpm/ft²), or about 8.2×10⁻⁵ to about 3.3×10⁻4 cubic meter per second per square meter cross-sectional area (meter/sec). A ratio of a diameter D of the upper portion 45 of the vessel 20 to a diameter D1 of the precipitation element 21 ranges from about 1.5 to about 2.8, or preferably from about 1.6 to about 2.2. In the illustrated embodiment, the lower portion of the vessel 20 is cone-shaped having a taper angle α of from about 60 to about 120 degrees. A ratio of a height H to the diameter D of the vessel 20 is not less than 0.2.

In some non-limiting examples, the vessel 20 may have other shapes, such as whole cylindrical shapes. Similarly, the precipitation element 21 may also comprise other shapes, such as cone shapes.

For the illustrated embodiment, a confining element 22 is provided to define a confinement zone 220 with at least a portion thereof disposed within the precipitation zone 24 and in communication with the precipitation zone 24 and the solid-liquid separation zone 200. As one example, the confining element 22 may comprise two open ends and have a hollow cylindrical shape having a uniform diameter.

Additionally, an agitation device 23 may be provided to extend into the confinement zone 220 so as to facilitate the flow of the liquid (or solid-liquid mixture) in the precipitation zone 24 and the confinement zone 220. The flow direction of the liquid (or solid-liquid mixture) agitated by the agitation device 23 may be from top to bottom or from bottom to top.

The ratio of the diameter D2 of an impeller 230 of the agitation device 23 to the diameter D of the vessel 20 ranges from about 0.2 to about 0.4. The ratio of the diameter Dc of the confining element 22 to the diameter D2 of the impeller 230 of the agitation device 23 ranges from about 1.0 to about 2.0. In some embodiments, the impeller 230 is a marine impeller having a diameter of about ¼ of the diameter of the vessel 20. In some embodiments, the impeller 230 is a straight pitched blade impeller having a diameter of about ⅓ of the diameter of the vessel 20. In some embodiments, the impeller 230 is an axial flow impeller comprising from about 2 to about 6 blades.

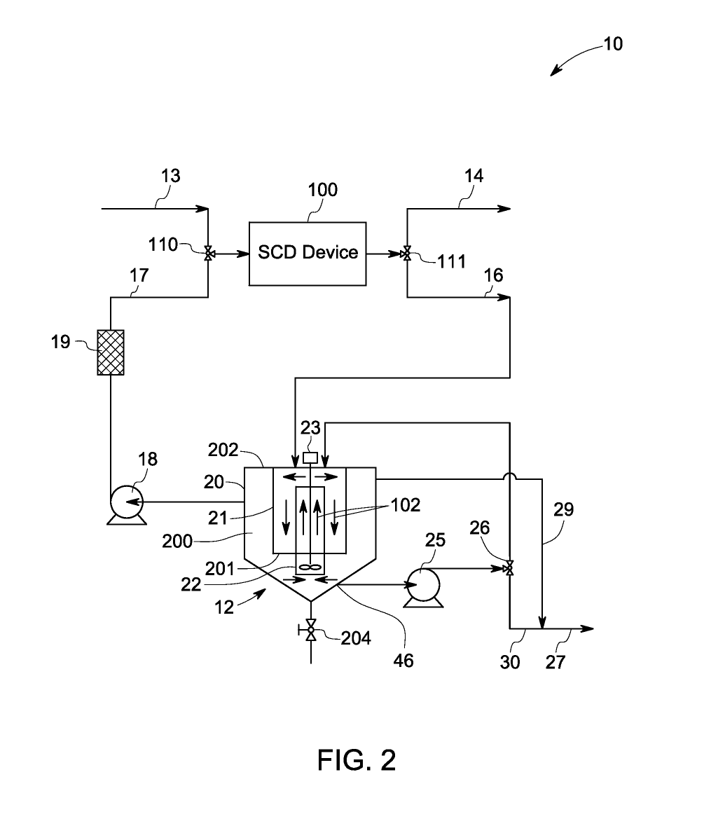

FIG. 2 is a schematic diagram of a desalination system 10 including the precipitation device 12 of FIG. 1 and a supercapacitor desalination (SCD) device 100. The term “SCD device” may generally indicate supercapacitors that are employed for desalination of seawater or deionization of other brackish waters to reduce the amount of salt or other ionized impurities to a permissible level for domestic and industrial use.

In certain applications, the supercapacitor desalination device may comprise one or more supercapacitor desalination cells (not shown). As is known, in non-limiting examples, each supercapacitor desalination cell may at least comprise a pair of electrodes, a spacer, and a pair of current collectors attached to the respective electrodes. A plurality of insulating separators may be disposed between each pair of adjacent SCD cells when more than one supercapacitor desalination cell stacked together is employed.

In embodiments of the invention, the current collectors may be connected to positive and negative terminals of a power source (not shown), respectively. Since the electrodes are in contact with the respective current collectors, the electrodes may act as anodes and cathodes, respectively.

For the illustrated arrangement, during the charging state of the supercapacitor desalination device 100, an input stream 13 from a liquid source (not shown) passes through a valve 110 and enters into the SCD device 100 for desalination. In this state, the flow path of an input stream 17 to the SCD device 100 is closed by valve 110. Positive and negative electrical charges from the power source accumulate on surfaces of the anode(s) and the cathode(s), respectively and attract anions and cations from the ionized input stream 13, which causes them to be adsorbed on the surfaces of the anode(s) and the cathode(s), respectively. As a result of the charge accumulation on the anode(s) and the cathode(s), an outflow stream, such as an output stream 14 from the SCD device 100 passing through valve 111 may have a lower salinity (concentration of salts or other ionic impurities) as compared to the input stream 13. In certain examples, the dilute outflow stream 14 may be subjected to de-ionization again by being fed through another desalination device or being redirected into the SCD device 100.

In the discharging state of the supercapacitor desalination device 100, the adsorbed anions and cations dissociate from the surfaces of the anode(s) and the cathode(s), respectively. The input stream 17 is pumped by pump 18 from the precipitation device 12, and passes through filter 19 and valve 110 to enter the SCD device 100 to carry ions (anions and cations) therefrom. An outflow stream 16 flowing from the SCD device 100 and passing through the valve 111 has a higher salinity (concentration of the salt or other ionic impurities) as compared with the input stream 17. In this state, the flow path of the input stream 13 to the SCD device 100 is closed by the valve 110. The filter 19 is configured to filter some particles to avoid clogging the SCD device 100. In certain applications, filter 19 may not be provided.

After discharging of the SCD device is complete, the SCD device is placed in the charging state for a period of time for preparation of a subsequent discharging. That is, the charging and the discharging of the SCD device are alternated for treating input streams 13 and 17, respectively.

In certain applications, the initial (input) stream 13 and the initial (input) stream 17 may or may not comprise the same salts or impurities, and may or may not have the same concentration of the salts or the impurities. In other examples, the concentration of the salts or impurities in the input stream 17 may or may not be saturated or supersaturated.

As the liquid is circulated through the SCD device in the discharging state, the concentration of salts or other ionic impurities in the liquid increases so as to produce precipitate. The precipitation device 12 is configured to precipitate solids from the first stream 16 and separate a part of the precipitate particles (solids) of the salts or other impurities by settling them into the lower portion of the vessel 20 by gravity before the liquid 17 is circulated into the SCD device 100 from the precipitation device 12.

As illustrated in FIG. 2, the output stream 16 is directed into the precipitation zone 24 from an upper end (not labeled) of the precipitation element 21 to precipitate solids, and then dispersed into the solid-liquid separation zone 200 from the lower opening 201 and/or the upper opening 202 of the precipitation element 21 for solid-liquid separation and circulation. The fluid (or fluid/solid mixture) flows in directions as indicated by arrows 102. The precipitate particles (solids) with diameters larger than a specified diameter may settle by gravity in the lower portion of the vessel 20. Other precipitate particles with diameters smaller than the specified diameter may be dispersed in the liquid.

When the precipitation rate plus a blow down rate of stream 27 equals the charged species removal rate from the input stream 13, where the rates are averaged over one or more charging-discharging cycles, the degree of saturation or supersaturation (saturation and supersaturation are interchangeable throughout this application) of the streams circulating between the SCD device and the precipitation device may stabilize and a dynamic equilibrium may be established.

In some embodiments, device 25 including a pump may also be provided to direct a portion of the liquid (recirculation stream) from a recirculation port 46 of the bottom portion of the vessel 20 to pass through a valve 26 and to enter into the precipitation zone so as to facilitate the flow of the liquid in the precipitation zone 24 and the confinement zone 220. After particle attrition, a portion of the precipitate particles in the recirculation stream may be sent back to be re-suspended in the liquid and to act as seed particles to thereby induce more precipitation in the precipitation zone 24. Normally, valve 26 blocks a flow path of discharge (waste) stream 27 pumped through the device 25.

In some embodiments, the confining element 22 may not be employed. Similarly, in particular embodiments, agitation device 23 and/or the pump 25 may not be provided.

In certain examples, the energy released in the discharging state may be used to drive an electrical device (not shown), such as a light bulb, or may be recovered using an energy recovery cell, such as a bi-directional DC-DC converter.

In other non-limiting examples, similar to the SCD cells stacked together, the supercapacitor desalination device 100 may comprise a pair of electrodes, a pair of current collectors attached to the respective electrodes, one or more bipolar electrodes disposed between the pair of electrodes, and a plurality of spacers disposed between each of the pairs of adjacent electrodes for processing input stream 13 in a charging state and second stream 17 in a discharging state. Each bipolar electrode has a positive side and a negative side, separated by an ion-impermeable layer.

In some embodiments, the current collectors may be configured as a plate, a mesh, a foil, or a sheet and formed from a metal or metal alloy. The metal may include titanium, platinum, iridium, or rhodium, for example. The metal alloys may include stainless steel, for example. In other embodiments, the current collectors may comprise graphite or plastic material, such as polyolefin, which may include polyethylene. In certain applications, the plastic current collectors may be mixed with conductive carbon blacks or metallic particles to achieve a certain level of conductivity.

The electrodes and/or bipolar electrodes may include electrically conductive materials, which may or may not be thermally conductive, and may have particles with small sizes and large surface areas. In some examples, the electrically conductive material may include one or more carbon materials. Non-limiting examples of the carbon materials include activated carbon particles, porous carbon particles, carbon fibers, carbon aerogels, porous mesocarbon microbeads, or combinations thereof. In other examples, the electrically conductive materials may include a conductive composite, such as oxides of manganese, or iron, or both, or carbides of titanium, zirconium, vanadium, tungsten, or combinations thereof.

Additionally, the spacer may comprise any ion-permeable, electronically nonconductive material, including membranes and porous and nonporous materials to separate the pair of electrodes. In non-limiting examples, the spacer may have or itself may be space to form flow channels through which a liquid for processing passes between the pair of electrodes.

In certain examples, the electrodes, the current collectors, and/or the bipolar electrodes may be in the form of plates that are disposed parallel to each other to form a stacked structure. In other examples, the electrodes, the current collectors, and/or the bipolar electrodes may have varied shapes, such as a sheet, a block, or a cylinder. Further, the electrodes, the current collectors, and/or the bipolar electrodes may be arranged in varying configurations. For example, the electrodes, the current collectors, and/or the bipolar electrodes may be disposed concentrically with a spiral and continuous space therebetween.

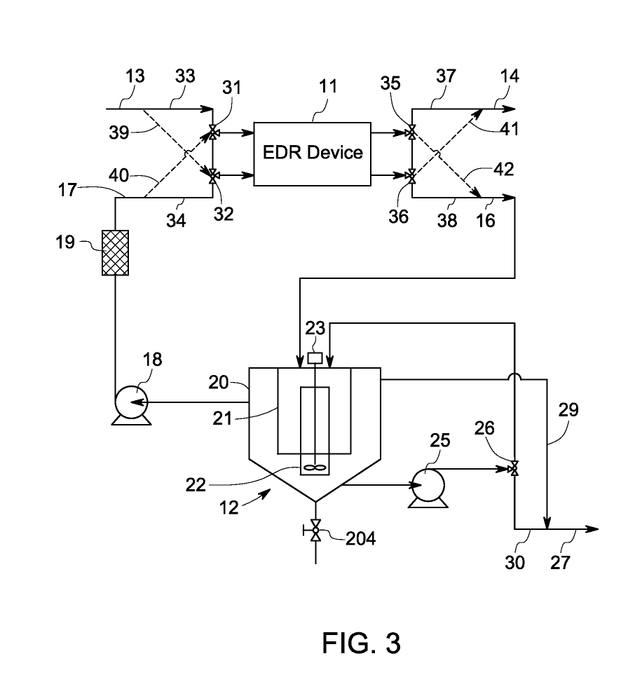

For certain arrangements, the precipitation device 12 may be used together with an electrodialysis reversal (EDR) device 11 as is shown in FIG. 3. The term “EDR” may indicate an electrochemical separation process using ion exchange membranes to remove ions or charged species from water and other fluids.

As is known, in some non-limiting examples, the EDR device comprises a pair of electrodes configured to act as an anode and a cathode, respectively. A plurality of alternating anion- and cation-permeable membranes are disposed between the anode and the cathode to form a plurality of alternating dilute and concentrate channels therebetween. The anion-permeable membrane(s) are configured to be passable for anions. The cation-permeable membrane(s) are configured to be passable for cations. Additionally, the EDR device may further comprise a plurality of spacers disposed between each pair of the membranes, and between the electrodes and the adjacent membranes.

Accordingly, while an electrical current is applied to the EDR device 11, liquids, such as the streams 13 and 17 (as shown in FIG. 3) pass through the respective alternating dilute and concentrate channels, respectively. In the dilute channels, the first stream 13 is ionized. Cations in the first stream 13 migrate through the cation-permeable membranes towards the cathode to enter into the adjacent channels. The anions migrate through the anion-permeable membranes towards the anode to enter into other adjacent channels. In the adjacent channels (concentrate channels) located on each side of a dilute channel, the cations may not migrate through the anion-permeable membranes, and the anions may not migrate through the cation permeable membranes, even though the electrical field exerts a force on the ions toward the respective electrode (e.g. anions are pulled toward the anode). Therefore, the anions and cations remain in and are concentrated in the concentrate channels.

As a result, the second stream 17 passes through the concentrate channels to carry the concentrated anions and cations out of the EDR device 11 so that the outflow stream 16 may be have a higher salinity than the input stream 17. After the circulation of the liquid in the EDR device 11, the precipitation of the salts or other impurities may occur in the precipitation device 12.

In some examples, the polarities of the electrodes of the EDR device 11 may be reversed, for example, every 15-50 minutes so as to reduce the fouling tendency of the anions and cations in the concentrate channels. Thus, in the reversed polarity state, the dilute channels from the normal polarity state may act as the concentrate channels for the second stream 17, and the concentrate channels from the normal polarity state may function as the dilution channels for the input stream 13.

Thus, in a state when the EDR device is at a normal polarity state, stream 13 from a liquid source (not shown) and stream 17 from a vessel 20, respectively, pass through first valves 31 and 32 along respective first input pipes, as indicated by solid lines 33 and 34 to enter into the EDR device 11. A dilute stream 14 and an outflow stream 16 pass through second valves 35 and 36 and enter into respective first output pipes, as indicated by solid lines 37 and 38.

When the EDR device is in a reversed polarity state, the streams 13 and 17 may enter the EDR device 11 along respective second input pipes, as indicated by broken lines 39 and 40. The dilute stream 14 and the outflow stream 16 may flow along respective second output pipes, as indicated by broken lines 41 and 42. Thus, the input streams and the output stream may be alternately entered into respective pipes to minimize the scaling tendency.

When the precipitation rate plus the blow down rate of stream 27 equals the removal rate of the charged species from stream 13, the degree of saturation or supersaturation of the liquid circulating between the EDR device and the precipitation device may stabilize and a dynamic equilibrium may be established.

In some EDR applications, the electrodes may include electrically conductive materials, which may or may not be thermally conductive, and may have particles with small sizes and large surface areas. The spacers may comprise any ion-permeable, electronically nonconductive material, including membranes and porous and nonporous materials. In non-limiting examples, the cation permeable membrane may comprise a quaternary amine group. The anion permeable membrane may comprise a sulfonic acid group or a carboxylic acid group.

In some embodiments, the precipitation of the salts or other impurities may not occur until the degree of saturation or supersaturation thereof is very high. For example, calcium sulfate (CaSO₄) often reaches a degree of supersaturation of 500% before precipitation occurs, which may be disadvantageous to the precipitation system. Accordingly, in certain examples, seed particles (not shown) may be added into the vessel 20 to induce precipitation on surfaces thereof at a lower degree of supersaturation of the salts or other ionic impurities. Additionally, the agitation device 23 and/or the pump 25 may be provided to facilitate suspension of the seed particles in the vessel 20.

In non-limiting examples, the seed particles may have an average diameter range from about 1 to about 500 microns, and may have a concentration range of from about 0.1 weight percent (wt %) to about 30 wt % of the weight of the liquid in the precipitation zone. In some examples, the seed particles may have an average diameter range from about 5 to about 100 microns, and may have a concentration range of from about 1.0 wt % to about 20 wt % of the weight of the liquid in the precipitation zone. In certain applications, the seed particles may comprise solid particles including, but not limited to CaSO₄ particles and their hydrates to induce the precipitation. The CaSO₄ particles may have an average diameter range from about 10 microns to about 200 microns. In some examples, the CaSO₄ seed particle concentration may be in a range of from about 0.1 wt % to about 2.0 wt % of the weight of the liquid in the precipitation zone, so that the concentration of CaSO₄ in the solution leaving precipitation device 12 may be controlled in a range of from about 100% to about 150% of saturation.

In other examples, one or more additives may be added into outflow stream 16 to reduce the degree of saturation or supersaturation of some species. For example, an acidic additive may be added into the EDR or SCD outflow stream 16 to reduce the degree of saturation or supersaturation of calcium carbonate (CaCO₃). In certain examples, the additives may or may not be added into the first stream 16.

It should be noted that seed particles and additives are not limited to any particular seed particles or additives, and may be selected based on specific applications.

In certain examples, a stream 29 may be discharged to remove a certain amount of the liquid to maintain a constant volume and/or to reduce the degree of saturation or supersaturation of some species in the vessel 20. The stream 29 may be mixed with a stream 30, which is removed from the bottom portion of the vessel 20 using pump 25 to form discharge (waste) stream 27.

In some examples, stream 30 may comprise ten or more weight percent of the precipitate. For these examples, valve 26 blocks the flow path for recirculation of the liquid to the vessel 20. Additionally, a valve 204 may be disposed on the lower portion of vessel 20 to facilitate evacuating the vessel 20.

It should be noted that precipitation device 12 is not limited to be used together with any particular supercapacitor desalination (SCD) device or any particular electrodialysis reversal (EDR) device.

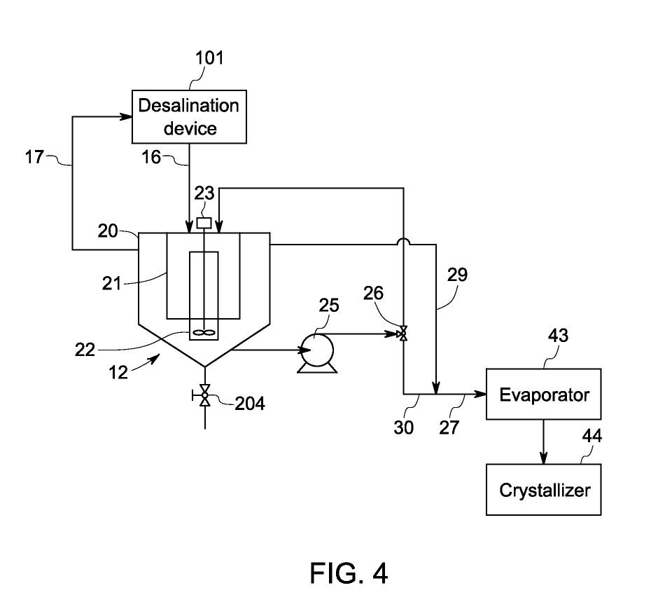

In addition, as depicted in FIG. 4, an evaporator 43 and a crystallizer 44 may be included to evaporate and crystallize discharge stream 27 from the precipitation device 12 so as to improve the water recovery or to achieve zero liquid discharge (ZLD). One skilled in the art may readily implement evaporator 43 and crystallizer 44. In one non-limiting example, crystallizer 44 may be a thermal crystallizer, such as a dryer. In certain applications, evaporator 43 and/or crystallizer 44 may not be employed. For ease of illustration, some elements are not depicted. The desalination device 101 shown in FIG. 4 may be any supercapacitor desalination (SCD) device, any electrodialysis reversal (EDR) device, any other desalination device, or any combination thereof.

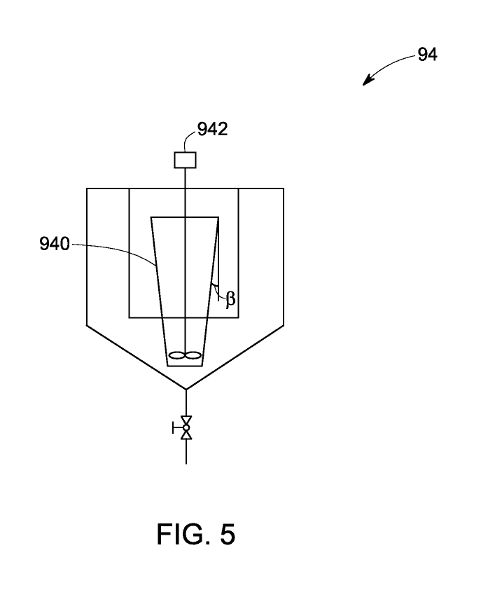

FIG. 5 shows a precipitation device 94 in accordance with another embodiment of the present invention. The precipitation device 94 is similar to the precipitation device 12 except that the precipitation device 94 comprises a conic (downwardly narrowing) confining element 940 having a half taper angle of from about 0 to about 20 degrees for better settling effects of solids (particles).

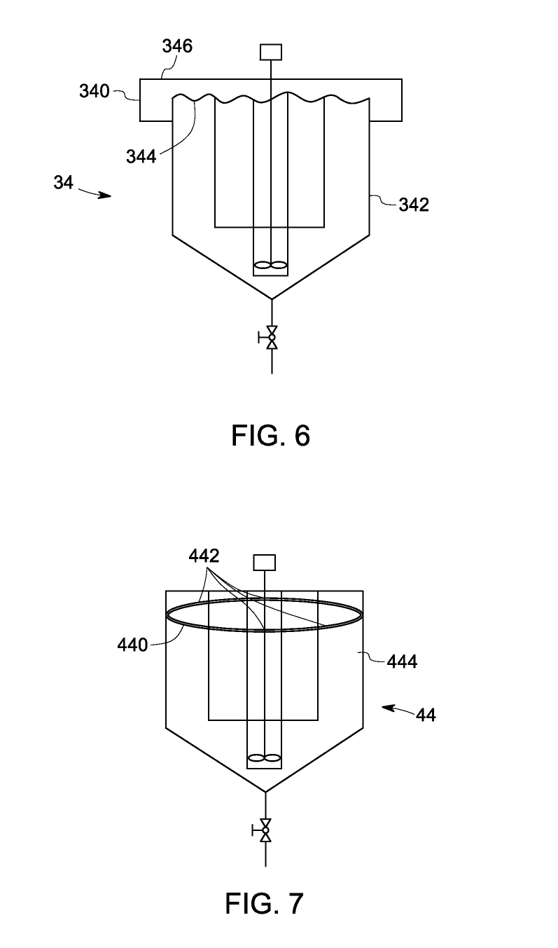

FIG. 6 illustrates a precipitation device 34 in accordance with another embodiment of the present invention. The precipitation device 34 comprises a skirt 340 located outside of the upper portion 342 of the precipitation device 34 and configured to accommodate fluid that overflows from the upper portion of the device 34. The upper edge 344 of the upper portion 342 is lower than the upper edge 346 of the skirt 340 and serves as an overflow device for liquids in the solid-liquid separation zone of the precipitation device 34. The upper edge 344 is in a wave shape or, alternatively, may comprise a series of v-notches.

FIG. 7 illustrates a precipitation device 44 in accordance with another embodiment of the present invention. The precipitation device 44 is similar to other devices described herein except that it comprises a hose 440 with multiple holes 442 in the solid-liquid separation zone 444 configured as the exit ports of the second stream to enhance the uniformity of the salinity of liquid in the solid-liquid separation zone 444.

In another aspect, the present invention relates to a method, comprising: providing a precipitation device comprising: a precipitation element disposed within a vessel and configured to define a precipitation zone and a solid-liquid separation zone between the precipitation element and the vessel; and an exit port located in an upper portion of the vessel; wherein a ratio of a diameter of the vessel to a diameter of the precipitation element ranges from about 1.5 to about 2.8; providing a first stream of saline liquid into the precipitation zone to precipitate solids from the saline liquid; settling the solids by gravity in the solid-liquid separation zone; and releasing a second stream of liquid of lower salinity than the first stream through the exit port.

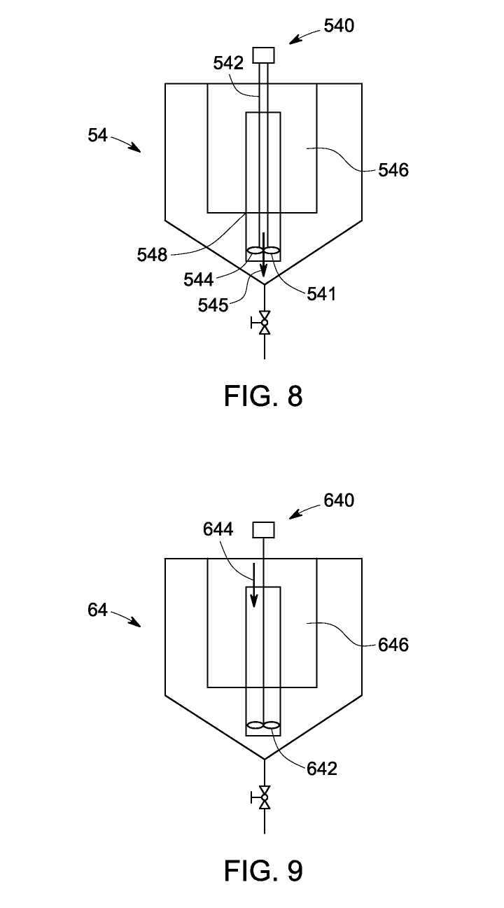

FIG. 8 depicts a precipitation device 54 in accordance with one embodiment of the present invention comprising an agitation device 540 comprising a hollow shaft 542 and an impeller 544. The first stream 545 passes through the hollow shaft 542 and enters the precipitation zone 546 from below the impeller 544. With stirring, a vacuum is formed under blades 541 of the impeller 544 to drive the first stream 545 upwards in the confining element 548.

Referring to FIG. 9, in accordance with another embodiment of the present invention, a precipitation device 64 comprises an agitation device 640 comprising an impeller 642 and the first stream 644 enters precipitation zone 646 from above the impeller 642.

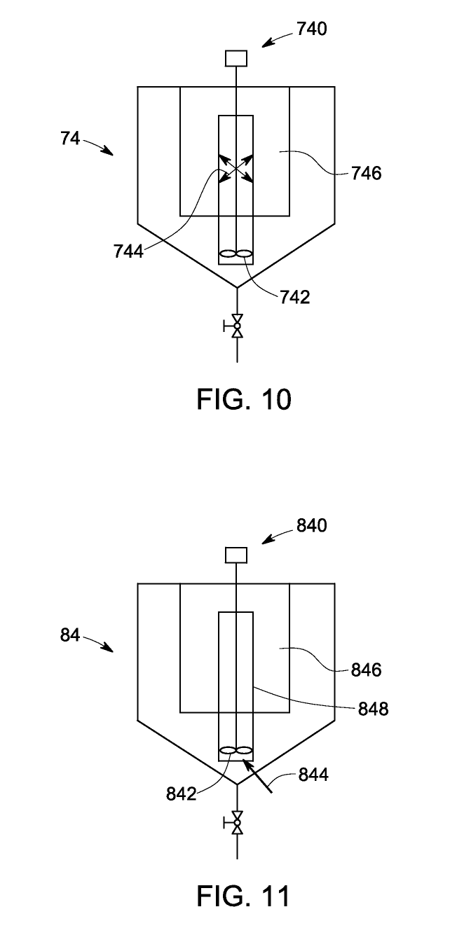

Referring to FIG. 10, in accordance with another embodiment of the present invention, a precipitation device 74 comprises an agitation device 740 comprising an impeller 742 and a plurality of first streams 744 enters precipitation zone 746 in different directions from above the impeller 742 to enhance the uniformity of salinity of liquid in the precipitation zone 746.

Referring to FIG. 11, in accordance with another embodiment of the present invention, a precipitation device 84 comprises an agitation device 840 comprising an impeller 842 and the feed stream 844 enters precipitation zone 846 at the bottom of the confining element 848 and from below the impeller 842.

In some embodiments, the first stream comprises calcium sulfate having a saturation or supersaturation degree of about 120% to 140%. The second stream comprises calcium sulfate having a saturation or supersaturation degree of about 100% to 120%.

Design features of various embodiments described herein can be replaced, interchanged or combined according to specific applications. The precipitation device yields liquid with desired quality at low cost and simple mechanism.

### Example

The following example is included to provide additional guidance to those of ordinary skill in the art in practicing the claimed invention. Accordingly, this example does not limit the invention as defined in the appended claims.

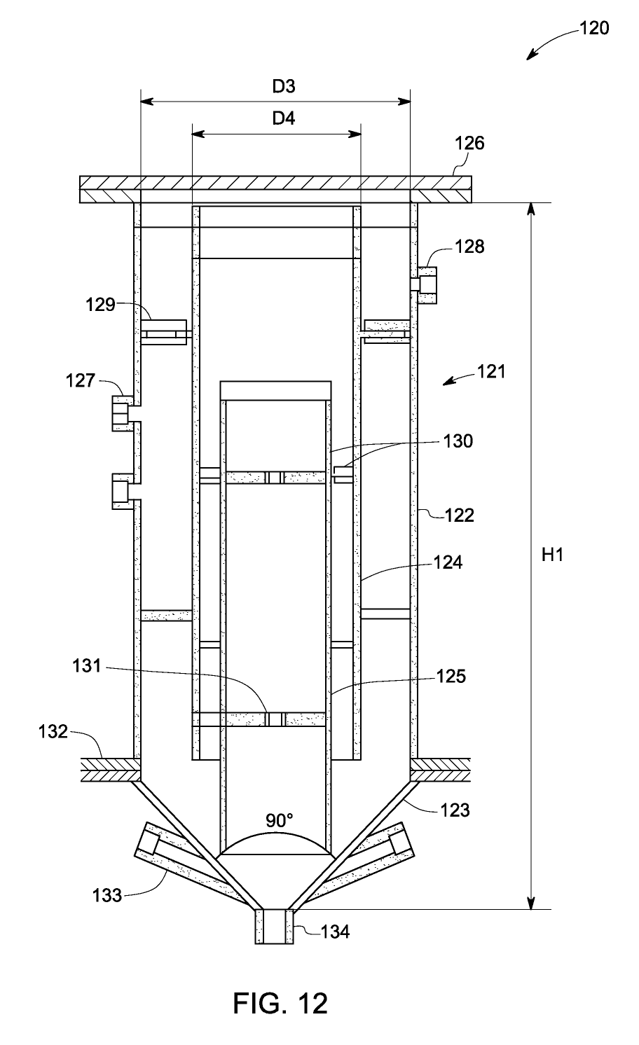

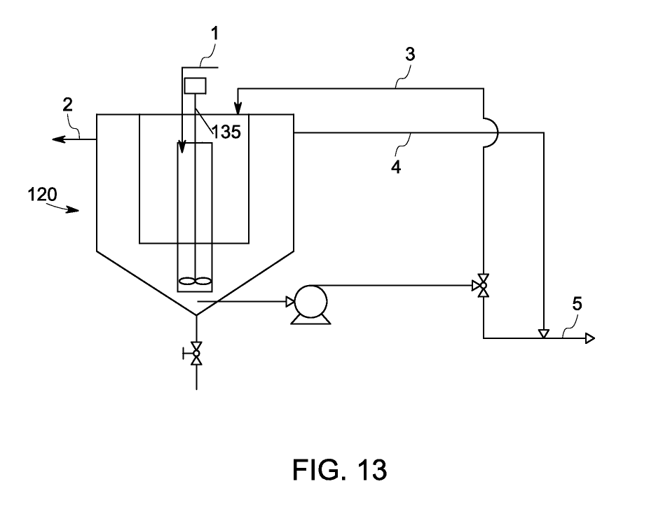

FIG. 12 shows a cross-sectional diagram of a precipitation device 120 used in the example. Vessel 121 of the precipitation device 120 made of polymethyl methacrylate has a height H1 of 635 mm, in which the upper portion 122 is 500 mm and the lower portion 123 is 135 mm. The upper portion 122 is a cylinder having a diameter D3 of 250 mm. The lower portion 123 is of cone shape and has a cone angle of 90 degrees. Precipitation element 124 is a cylinder having a diameter of 150 mm and a height of 500 mm. Confining element 125 is a cylinder having a diameter of 100 mm and a height of 402 mm. A three-blade agitation device 135 (IKA® RW 20 Digital, schematically shown in FIG. 13) was put in the confining element 125 and comprises a shaft and an impeller having a diameter of 80 mm. The stirring rate of the impeller was 300 rpm.

The tops of the vessel 121 and precipitation element 124 are flush. Cover 126 covers the tops of the vessel and the precipitation element to protect from dust and has a diameter of 350 mm. There are two sample ports 127 and one product stream exit port 128. The vessel 121 supports the precipitation element 124 by engagement structures 129 and the precipitation element supports the confining element 125 by connecting structures 130. In the confining element 125, bearings 131 are provided for supporting the shaft of the agitation device. The precipitation device 120 is mounted on a base 132 in such a way that the lower portion 123 is located below the base. The lower portion comprises two outlets 133 extending upward from the bottom of the lower portion, one as a recirculation port, the other one for backup in case the first one becomes plugged, and one valve 134 extending downward from the bottom of the lower portion for slurry discharge.

FIG. 13 shows a schematic operation view of the precipitation device 120 of FIG. 12. The process was operated as a continuous process and the precipitation device was filled before start-up with 20 liter of feed water, the composition of which was shown in the Table 1 as “Initial Feed”. Calcium sulfate dihydrate (200 g, particle diameters of 50-200 micron obtained from Kecheng Thermal Insulator Material Co. Ltd, Shanghai, China) was added as seed particles in the precipitation element 124 before the start up of the process.

The input stream (stream 1, FIG. 13), which was the output stream from an SCD stack (not shown) during the discharging state, was fed to the precipitation device 120. Each operation cycle of the SCD stack comprised a 30-minute discharging state followed by a 15-minute charging state. The composition of stream 1 is shown in Table 1 below. The calcium sulfate concentration in the stream 1 was about 123.20% of saturation. The treated stream (stream 2) returned to the SCD stack. The composition of stream 2 is shown table 1, the concentration of calcium sulfate was only about 113.80% of saturation.

The water flow rate of inlet stream 1 and outlet stream 2 in and out of the vessel 122, respectively, was controlled at 500 ml/min, which corresponds to 8.6 cm/sec linear velocity. The flow rate per unit cross-sectional area in the solid-liquid separation zone is about 0.25 gpm per square foot (gallons per minute per square foot) or 1.7×10⁻⁴ cubic meter per second per square meter. Since the seeds have a tendency to continue to grow during each 45-minute cycle, a recirculation stream (stream 3) at a flow rate of 6000 ml/min operates for 4 minutes during each 30-minute feed portion of the 45-minute cycle to keep the particle size and distribution stable. The water volume in the precipitation device was kept constant by using an overflow stream (stream 4). To maintain a stable seed inventory, there was a 2-second blowdown step in the 30-minute feed during each 45-minute cycle. During the blowdown step, 75 ml of slurry (in stream 5) was discharged. About 6-7 gram of particles were filtered out from the blowdown slurry. During the blowdown step, the overflow stream 4 feeds into the stream 5.

TABLE 1

| | Initial feed | stream 1 | stream 2 |
|---|---|---|---|
| Na⁺ (ppm wt/wt) | 297 | 5033.9 | 5007 |
| K⁺ (ppm wt/wt) | 41.5 | 1286.8 | 1265 |
| Ca²⁺ (ppm wt/wt) | 210.2 | 1144.1 | 1072 |
| Mg²⁺ (ppm wt/wt) | 59.9 | 550.7 | 549 |
| Cl⁻ (ppm wt/wt) | 530 | 8952.4 | 8845 |
| HCO₃⁻ (ppm wt/wt) | 162 | 299.2 | 242 |
| SO₄²⁻ (ppm wt/wt) | 595 | 4824.9 | 4578 |
| Calcium sulfate saturation degree | 24.8% | 123.20% | 113.80% |

The particle concentration in the outlet stream 2 was measured by filtration to be about 11 ppm. Optical microscopy images from a Nikon ECLIPSE Ti microscope showed that the water quality of outlet (stream 2) was comparable to deionized water. The turbidity of stream 2 was measured daily with a HACH 2100AN TURBIDMETER. Table 2 shows the turbidity data.

TABLE 2

| | Day | | | | | | | | | | | |
|---|---|---|---|---|---|---|---|---|---|---|---|---|
| | 1 | 2 | 3 | 4 | 5 | 6 | 7 | 8 | 9 | 10 | 11 | 12 |
| Turbidity | 2.06 | 1.75 | 1.72 | 2.13 | 1.98 | 2.34 | 2.12 | 1.88 | 2.27 | 2.02 | 2.11 | 2.04 |
| (NTU) | | | | | | | | | | | | |

In summary, the saturation degree of CaSO₄ was decreased by the precipitation device and the system operation is very stable.

While the disclosure has been illustrated and described in typical embodiments, it is not intended to be limited to the details shown, since various modifications and substitutions can be made without departing in any way from the spirit of the present disclosure. As such, further modifications and equivalents of the disclosure herein disclosed may occur to persons skilled in the art using no more than routine experimentation, and all such modifications and equivalents are believed to be within the spirit and scope of the disclosure as defined by the following claims.

What is claimed is:

1. A precipitation device comprising:
a precipitation element disposed within a vessel and configured to define a precipitation zone and a solid-liquid separation zone between the precipitation element and the vessel, the precipitation zone configured to receive a first stream of saline liquid and precipitate solids from the saline liquid, the solid-liquid separation zone configured to settle the solids by gravity; and
an exit port located in an upper portion of the vessel and configured for exit of a second stream of liquid of lower salinity than the first stream;
wherein
a ratio of a diameter of the vessel to a diameter of the precipitation element ranges from about 1.5 to about 2.8.

2. The precipitation device of claim 1, wherein the ratio of the diameter of the vessel to the diameter of the precipitation element ranges from about 1.6 to about 2.2.

3. The precipitation device of claim 1, wherein a ratio of a height to the diameter of the vessel is about equal to or more than 0.2.

4. The precipitation device of claim 1, wherein the vessel comprises a conic lower portion having a taper angle of from about 60 to about 120 degrees and comprising a recirculation port for recirculation of liquid and solids into the precipitation zone.

5. The precipitation device of claim 1, wherein the upper portion of the vessel comprises an overflow port located vertically higher than the exit port.

6. The precipitation device of claim 1, further comprising a skirt located outside of the upper portion to accommodate fluid overflowed from the upper portion of the vessel and comprising an upper edge higher than a wave-shaped or v-notched upper edge of the upper portion.

7. The precipitation device of claim 1, wherein there are a plurality of exit ports around the vessel.

8. The precipitation device of claim 1, further comprising an agitation device to facilitate precipitation.

9. The precipitation device of claim 8, wherein the agitation device has an impeller with a diameter of about 0.2 to about 0.4 of the diameter of the vessel and about 2 to about 6 blades.

10. The precipitation device of claim 1, further comprising a confining element located inside the precipitation element and in fluid communication with the precipitation element from upper and lower ends thereof.

11. The precipitation device of claim 10, wherein the confining element has a half taper angle of from about 0 to about 20 degrees.

12. The precipitation device of claim 10, further comprising an agitation device extending in the confining element and comprising an impeller to facilitate precipitation and wherein a ratio of a diameter of the confining element to a diameter of the impeller is from about 1.0 to about 2.0.

13. A system comprising the precipitation device of claim 1, further comprising a desalination device providing the first stream to the precipitation device and receiving the second stream from the precipitation device.

14. The system of claim 13, wherein the desalination device comprises a supercapacitor desalination device or an electrodialysis reversal device.

15. A method, comprising:
providing a precipitation device comprising:
a precipitation element disposed within a vessel and configured to define a precipitation zone and a solid-liquid separation zone between the precipitation element and the vessel; and
an exit port located in an upper portion of the vessel; wherein
a ratio of a diameter of the vessel to a diameter of the precipitation element ranges from about 1.5 to about 2.8;
providing a first stream of saline liquid into the precipitation zone to precipitate solids from the saline liquid;
settling the solids by gravity in the solid-liquid separation zone; and
releasing a second stream of liquid of lower salinity than the first stream through the exit port.

16. The method of claim 15, further comprising agitating using an agitation device to facilitate precipitation, wherein the agitation device comprises a hollow shaft and the first stream passes through the hollow shaft to enter the precipitation zone from below the agitation device.

17. The method of claim 15, further comprising agitating using an agitation device to facilitate precipitation, wherein the agitation device comprises a impeller and the first stream enters the precipitation zone from above the impeller or from below the impeller.

18. The method of claim 15, comprising providing a plurality of first streams that are introduced in different directions into the precipitation zone.

19. The method of claim 15, wherein a liquid flow rate per unit cross sectional area in the solid-liquid separation zone is from about 0.12 to about 0.48 gallons per minute per square foot (0.82×10⁻⁴ to 3.3×10⁻⁴ cubic meter per second per square meter).

20. The method of claim 15, further comprising providing an initial charge of seed particles in the vessel.
